(19) United States
(12) Patent Application Publication
(10) Pub. No.: US 2016/0247145 A1
(43) Pub. Date: Aug. 25, 2016

(54) WEARABLE ACCESS AND TRACKING SYSTEM FOR RESERVED SEATING EVENTS

(71) Applicant: INTELLITIX TECHNOLOGIES INC., Montreal (CA)

(72) Inventor: Serge Grimaux, Prague (CZ)

(21) Appl. No.: 15/048,551

(22) Filed: Feb. 19, 2016

Related U.S. Application Data
(60) Provisional application No. 62/118,599, filed on Feb. 20, 2015.

(51) Int. Cl. G06Q 20/32; G06Q 30/02; G06K 19/07; G06K 7/10; G06Q 10/02; G06Q 20/40

(52) U.S. Cl. CPC G06Q 20/3278; G06Q 10/02; G06Q 20/405; G06K 19/0723; G06K 7/10415; G06Q 20/3224; G06Q 30/0236

(57) ABSTRACT

A wearable RFID band is provided for use at a reserved seating event. The band has a band element worn by a user, and an RFID tag printed on the band element. The RFID tag has stored data representing a UserID of the tag, seat information of the associated user, and a stored funds balance preloaded by the user to an associated account. The tag is programmed for activating an otherwise inactive terminal upon presentation of the tag in a first tap, and communicating the UserID to the terminal for a first validation against valid UserIDs and associated user data stored on a server. The tag is further programmed, following a transaction request and a second tap of the tag at the RFID reader, for triggering a second validation that the UserID at the second tap matches the UserID of the first tap. The transaction request is granted only if both of the validations are positive.

### PRIORITY

This application claims the benefit of U.S. Provisional Patent Application No. 62/118,599, filed Feb. 20, 2015, which is incorporated herein by reference in its entirety.

### FIELD OF INVENTION

The field of invention is generally related to wearable RFID devices, and more particularly relates to RFID devices used for cashless electronic payments in a closed system for reserved seating events.

### BACKGROUND

Arenas, stadiums, theatres, concert halls and auditoriums halls are buildings which serve as performance venues and provide a space for an audience to experience a live event e.g. a sport event, a concert or a drama. The audience is usually separated from the artists, performers, or athletes and regardless of the venue artists usually perform on a stage.

A concert is a live performance of music before an audience. The performance may be by a single musician, a musical ensemble, for example an orchestra, a choir, or a musical band. A drama uses live performers to present the experience of a real or imagined event before a live audience in a specific place. A sporting performance is a sporting competition of any sort.

While some performances can be free, generally it is a common practice to charge money for concerts by selling admission tickets. The seating areas in such venues can include some or all of the following e.g. stalls or arena; balconies or galleries; and or boxes. The price charged for seats in each part of the venue usually varies according to the quality of the view of the main point of attraction, being sometimes a stage and sometimes a sports field or ground. In some cases, the price charged for seats is based on the distance from the point of attraction to the seat.

Additional revenue is also often raised through in-event advertising; concessions and merchandise are also often sold during and after events at the venue. Since the nature of such events is temporary, and the vendors participating in these events may be small local vendors who have limited to no technology at their disposal, consumer information gathering at such events is generally not possible.

Manual tools for reaching consumers and gathering consumer information have traditionally been used at concerts and other such live events where reserved seating is required. Marketing material may be distributed by vendors, such as coupons, vouchers, business cards, flyers, etc. at the time of registration or entrance to the venue or already placed on the reserved seats (or through ads printed on admission tickets). Typically consumers attending such events also require cash for sampling or purchasing the advertised items. Such methods are outdated as they are bulky, expensive and environmentally unfriendly.

A consumer is also required to keep cash or coins on hand to make these transactions which can be very inconvenient. For the vendors, it takes a lot of time to complete a sale when dealing with cash/coin based transactions, since they must count the cash amount handed by the consumer and provide the exact change back to the consumer. The vendors must also ensure that they don't run out of change. While when closing the day for sales all cash must be counted, added and taken safely to be deposited at a bank or other financial institution.

To compound this problem, consumers have steadily been moving away from cash based transactions as they don't want to have the hassle of carrying cash and coins which can also be easily lost in the rush of an event. One method to overcome this limitation is to use touchless and cashless transaction methods that provide convenience and save time. One method of achieving touchless and cashless transactions are credit and debit cards embedded with RFID (Radio-frequency identification) tags. RFID tagged credit and debit cards allow for a “tap and go” style of payment because the information is transmitted wirelessly. Two-way radio transmitter-receivers called readers send a signal to the tag and read its response. In such a transaction the user is not required to sign a piece of paper or to enter the PIN number, and neither there is any verification of signature. This facilitates small, low-risk transactions.

Radio-frequency identification (RFID) is the wireless non-contact use of radio-frequency electromagnetic fields to transfer data, for the purposes of automatically identifying and tracking tags attached to objects. The tags contain electronically stored information. Some RFID tags are powered by and read at short ranges (a few centimeters) via electromagnetic induction. Other types of RFID tags may use a local power source such as a battery, or else have no battery but collect energy from the interrogating electromagnetic field, and then act as a passive transponder to emit microwaves or UHF (ultra high frequency) radio waves. Unlike a bar code, the RFID tag does not necessarily need to be within line of sight of the reader, and may be embedded in an object.

RFID tags can be passive or active or battery-assisted passive. A passive tag is cheaper and smaller because it has no battery. An active tag has an on-board battery and periodically transmits its ID signal. A battery-assisted passive (BAP) tag has a small battery on board and is activated when in the presence of an RFID reader.

Tags may either be read-only, having a factory-assigned serial number that is used as a key into a database, or may be read/write, where object-specific data can be written into the tag by the system. Field programmable tags may be write-once, read-multiple. “Blank” tags may be written with an electronic product code by the user.

Generally fixed RFID readers are set up to create a specific interrogation zone which can be tightly controlled. This allows a highly defined reading area for when tags go in and out of the interrogation zone. Mobile RFID readers may be hand-held or mounted on carts or vehicles.

Despite advances in technology, for events requiring reserved seating, in most cases, paper tickets or the like are needed. E-tickets may be e-mailed to the consumer who is then expected to print them and bring them to the event to gain entrance to the venue and to be seated on the reserved seat. Such methods are inconvenient, bulky and environmentally wasteful.

Such methods also lack information gathering about consumer sampling/purchasing at concerts and such events. Since the duration of such events is so brief, conventional methods for setting up and collecting consumer behaviour information are not suitable or may cost too much to provide a meaningful business benefit. Thus consumer information is neither collected nor compiled in real time to be useful due to the brevity of the event. Thus a wholesale change is needed in the way brands and/or vendors and/or manufacturers (distributors, event organizers, exhibitors, etc.) engage with their audience from basic entry all the way to post event communication and data mining.

### SUMMARY

Broadly speaking, the present invention relates to a system and method of electronic touchless payments; and collection and use of consumer data utilizing RFID tags embedded in wristbands or similar wearable items so that it can be advantageously used in events that have designated seating, which are inherently brief in nature (e.g. concerts and sporting events).

Replacing the manual and paper based ways of conveying seat designation information, the seat information, event information, and ticket holder information are written on the RFID wristband upon its purchase or remittance to the purchaser. This wristband may also be used for coupon dissemination, gathering consumer sampling and purchasing information, and digital payments, with the aim of stimulating commercial transactions between vendors and the consumers.

Through the RFID technology, event goers are able to engage with event vendors during and after the event. The RFID cashless payment system also enables consumers to spend more since it is convenient (as there is no need to carry cash), and transaction processing is faster.

In the preferred embodiment an RFID band is provided that can be worn by a consumer. Wristband examples are given as examples of suitable wearables in this disclosure, however, it should be understood that the wearable band may in fact be a wristband, headband, ankleband, ring, necklace, fob, tag, badge, eyewear or lanyard, or any other format wearable on a user's body.

The initial state of the terminal is an inactive state. When the consumer taps the RFID tag to the RFID reader, the RFID reader reads the RFID tag which activates the terminal. The terminal is only activated once a valid RFID tag has been tapped at the RFID reader by a consumer. This prevents a staff person (or other third party) from fraudulently adding any items unwanted by the consumer to the order. The system checks the validity of the RFID tag by comparing the UserID of the RFID tag with the UserIDs stored in the database on the server. If RFID tag is valid, only then can products be added to the sales transaction (or the transaction otherwise proceed). Once the consumer confirms the transaction with the second tap of the RFID tag to the RFID reader, the system validates the RFID tag a second time by comparing the UserID of the RFID tag captured with the first tap with the UserID of the RFID tag captured with the second tap. Only when the UserIDs of the two RFID tag taps are the same is the transaction completed. In the case of a sales transaction, funds are transferred from the RFID tag to the sales merchant. With the completion of the transaction the terminal returns to an inactive state.

In one embodiment a user buys a ticket to an event with designated seating e.g. a concert being held at a particular date and a particular venue. In one embodiment the RFID wristband is delivered immediately to the consumer upon purchase at a venue box office via a thermal printer or at a point of sale located anywhere and equipped with a thermal printer or at the entrance of the event venue where the “document confirming an online purchase” is swapped for an RFID band.

The wearable RFID band may be printed with the information about the assigned seating e.g. the section, row and seat number—as well as other information such as the name of the customer, the logo of commercial partner, specific information aimed to that consumer, etc.—allowing consumer to benefit from the use of the RFID technologies in a reserved seated environment.

In one embodiment the wearable RFID band is generated by a thermal printer. A thermal printer may be used for encoding wristbands and tags, passive RFID smart labels and cards.

There may be an option to load funds/add a balance in advance to attending the event. For example, at the time of buying tickets, a consumer may opt to add $100 that can then be used via the wearable RFID band to sample or purchase different products being showcased or sold at the event. Thus when the consumer arrives at the event and is given the wearable RFID band that has the designated seating information, it includes a privilege to spend $100 at the different sales booths set up at the venue. The RFID band may also have coupons for certain products.

In one embodiment a connected server stores the unique UserIDs of wearable RFID bands for consumers and also stores the designated seating information. The connected server is accessible over a network e.g. a LAN or a WAN or over the internet.

In one embodiment the system and method may be implemented in a closed-loop transaction model. In closed-loop payment networks, the payment services are provided directly to merchants and cardholders by the owner of the network without involving third-party financial institution intermediaries. Closed-loop payment networks can range in size from networks such as American Express and Discover, which issue cards directly to consumers and serve merchants directly, to an individual merchant that issues limited-purpose private-label credit cards to its customers for use only in that merchant's stores.

In the preferred embodiment the closed-loop payment network may be implemented using Intellitix Virtual Tokens; where a Virtual Token is a credit acquired by the consumer via Intellitix cashless application which can thereafter be used to pay for purchases made at the event where the closed loop network is deployed.

In one embodiment the connected server stores information about the funds added by the consumer which are available on the wearable RFID band for the consumer to spend at the event. The connected server is accessible over a network e.g. a LAN or a WAN or over the internet.

In one embodiment each vendor participating at the event is provided with a unique VendorID. Such vendors may include for example food and beverage vendors and merchandise vendors for products such as T-shirts, jerseys, fan memorabilia, posters, CDs, DVDs etc.

In one embodiment each vendor product that is being showcased/sold at the event is provided with a unique ProductID. Since each vendor may have multiple products that they are vending to the consumers attending the event, each VendorID may be associated with multiple ProductIDs.

In one embodiment each vendor participating at the event may also have one or more coupons. Coupons may be for select products that are discounted for specific customers (or subject to other offers, freebies, or package deals). Each coupon has a unique CouponID, and one VendorID may be associated with multiple CouponIDs.

In one embodiment a connected server stores the unique the unique VendorIDs, unique ProductIDs and unique CouponIDs for all vendors participating at the event. The connected server is accessible over a network e.g. a Local Area network (LAN) or a Wide Area Network (WAN) or over the internet. The unique VendorIDs and unique ProductIDs may be stored in a database or a file.

In one embodiment the server acquires consumer information. This information may be acquired from a local source such as a database where consumer information has been accumulated over a period of time.

In one embodiment the server analyzes consumer information gathered over a period of time from one or more events where the consumer may have purchased or sampled different products. Such information may include but is not limited to user likes/dislikes on different social media networks e.g. Facebook, past purchases, sampling at different events, previous seat selection, dollar amounts spent, coupons previously used, etc.

In one embodiment coupons may be selected for a user from a list of available coupons and matched based on consumer information analyzed earlier.

In one embodiment the UserID of the consumer may be matched with one or more CouponIDs of the selected coupons. Thus one UserID may be associated with one or more CouponIDs. In one embodiment the CouponIDs may be printed on the wearable RFID band with the UserID.

In one embodiment the UserIDs and the associated CouponIDs are saved to the server and saved to the wearable RFID band of the consumer. In an alternate embodiment the UserIDs and the associated CouponIDs are only saved to the server and are retrieved when a consumer taps the wearable RFID band at a sales terminal using UserID to query the server to see which coupons are associated with the said UserID.

Each consumer may be given an wearable RFID band at the start of the event (by printing and distributing the bands at the venue). In alternate embodiments when a consumer is purchasing the tickets or paying for the admission to the event online in advance, the wearable RFID band may be mailed to them prior to the start of the event.

In the preferred embodiment the wearable RFID band may be printed at the time when the consumer arrives at the event. In one embodiment each wearable RFID band has a unique UserID. This UserID may be printed to the generic RFID band using the RFID printing.

In one embodiment consumer seat information is available on the wearable RFID band. In one embodiment the seat information of each consumer and the associated UserIDs are stored on the server and the information read from the wearable RFID band tap is validated against the information stored in the server.

In one embodiment consumer loaded funds are available on the wearable RFID band. In one embodiment select coupons are available on the wearable RFID band. One or more coupons may be associated with the UserID of the wearable RFID band and available to the consumer for purchasing and/or sampling different products and services at the event.

In one embodiment real time information may be gathered using wearable RFID bands e.g. each time a consumer samples or purchases one or more products using the coupons on the wearable RFID band, information may be gathered as to whether the consumer availed himself of the deal(s) offered via the coupon(s), when the consumer entered a particular store at the event, what products were sampled or purchased in what order they were sampled or purchased, and when did the consumer leave the store.

In one embodiment gathered information may be compiled about consumer's visits to different stores during an event and compile gathered information about the coupons used, products purchased or sampled at each of the stores visited by the consumer. In one embodiment compiled information may be shared with a vendor. For example, the vendor may be sent information about how many consumers visited the vendor's store and what coupons from the wearable RFID band were used, what products were purchased and sampled. Similarly information may be shared with a consumer about their visit to different stores, including which coupons were used, and which products they may have purchased or sampled.

Optionally a method may be provided to check the zone restrictions/privileges associated with the wearable RFID band. For example an event may have one or more areas e.g. boxes or balconies, and thus is divided into one or more zones. The various zones may be required in order to segregate the consumers based on their payment levels.

According to a first aspect of the invention, a wearable RFID band is provided for use at an event in a reserved seating interrogation zone. The zone contains terminals with RFID readers. The band has a band element worn by a user, and an RFID tag printed on the band element. The RFID tag has stored data representing a UserID of the tag, seat information of the associated user, and a stored funds balance preloaded by the user to an associated account. The tag is programmed for activating an otherwise inactive one of the terminals upon presentation of the tag to the RFID reader of said terminal in a first tap, and communicating the UserID to the terminal for a first validation against valid UserIDs and associated user data stored on a server. The tag is further programmed, following a transaction request and a second tap of the tag at the RFID reader, for triggering a second validation that the UserID at the second tap matches the UserID of the first tap. The transaction request is granted only if both of the validations are positive.

The transaction request may be a gate admission, or a zone admission. The transaction request may also be for a purchase of a good or service for a transaction amount wherein grant of the request entails a decrease of the stored funds balance by the transaction amount. The transaction request may also be for a top-up transaction by a transaction amount wherein grant of the request entails an increase of the stored funds balance by the transaction amount. The transaction request may also be for a refund transaction by a transaction amount wherein grant of the request entails an increase of the stored funds balance by the transaction amount.

Preferably, the band element is configured to be worn (at least in part) around (or on) a body part of the user. The band element may be, for example, a wristband, headband, ankleband, ring, necklace, fob, tag, badge, eyewear, or lanyard.

Befitting the temporary nature of the event, the band element may be a disposable element.

The RFID tag may printable on the band element at the event. (Or, the band element may be pre-printed and mailed or otherwise distributed to users in advance of the event.)

Preferably, the RFID tag is an ICODE SLI2 15693 tag. Preferably, the RFID tag communicates with the readers using an Active Reader Passive Tag (ARPT) system.

The tag may be programmed to deactivate or hibernate after a predetermined time, or following the event.

The stored data may also include at least one credential. For example, the credential may be an age or date of birth credential.

The interrogation zone may be in a stadium, arena, concert hall, theatre, or auditorium (or other event venue).

Preferably, the tag is further programmed to cause the reader to communicate a timestamp associated with the transaction request when granted. For example, a timestamped record of all transaction requests may be stored associated with the user. A timestamped record of all transaction requests associated with the event may also be stored.

The stored data may also include at least one CouponID associated with a coupon for a good or service having a ProductID. The coupon is retrieved and automatically processed when the user's transaction request for a purchase associated with the ProductID is granted. The coupon may be selected for the user based on associated user data stored on the server.

### BRIEF DESCRIPTION OF THE FIGURES

FIG. 1 is a flow diagram illustrating a basic method for issuance and use of RFID wristbands for an event.

FIG. 2 is a flow diagram illustrating the use of VendorID, ProductID and CouponID codes.

FIG. 3 is a flow diagram illustrating the selective issuance of coupons.

FIG. 4 is a flow diagram illustrating the issuance and use of RFID wristbands at an event.

FIG. 5 is a flow diagram illustrating the use of RFID wristbands for purchase transactions with coupons at an event.

FIG. 6 shows a flow diagram of compilation of information from RFID wristband use at an event.

FIG. 7 shows a sample wearable band (here, wristband) in “tapping” communication with an RFID reader portion of a terminal (for an admission, sales or top-up transaction).

### DETAILED DESCRIPTION

Before embodiments are explained in detail, it is to be understood that the invention is not limited in its application to the details of the examples set forth in the following descriptions or illustrated drawings. The invention is capable of other embodiments and of being practiced or carried out for a variety of applications and in various ways. Also, it is to be understood that the phraseology and terminology used herein is for the purpose of description and should not be regarded as limiting.

Before embodiments of the software modules or flow charts are described in detail, it should be noted that the invention is not limited to any particular software language described or implied in the figures and that a variety of alternative software languages may be used for implementation.

It should also be understood that many components and items are illustrated and described as if they were hardware elements. However, it will be understood that, in at least one embodiment, the components comprised in the method and tool are actually implemented in software.

The present invention may be embodied as a system, method or computer program product. It may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium. In order to provide a context for the various aspects of the disclosed invention, as well as the following discussion are intended to provide a brief, general description of a suitable environment in which the various aspects of the disclosed invention may be implemented. While the invention has been described in the general context of computer-executable instructions of a program that runs on one or more computers, the invention may also be implemented in combination with other program modules. Generally, program modules include routines, programs, components, data structures, etc. that perform particular tasks and/or implement particular abstract data types. The system and method may be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch or other electronic gadgets incorporating the capacity to compute), microprocessor-based or programmable consumer or industrial electronics, and the like. The illustrated aspects may also be practiced in distributed computing environments where tasks/routines/processes etc. are performed by remote processing devices that are linked through a communications network e.g. a local area network (LAN) or the Internet. However, some, if not all aspects may be practiced on stand-alone computer(s). In a distributed computing environment, program modules may be located in both local and remote memory storage devices.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. Computer code may also be written in dynamic programming languages that describe a class of high-level programming languages that execute at runtime many common behaviours that other programming languages might perform during compilation. JavaScript, PHP, Perl, Python and Ruby are examples of dynamic languages. Additionally computer code may also be written using a web programming stack of software, which may mainly be comprised of open source software, usually containing an operating system, Web server, database server, and programming language. Some embodiments may use well-known open-source Web development platforms using Linux, Apache, MySQL and PHP. Other examples of environments and frameworks using which computer code may also be generated are Ruby on Rails which is based on the Ruby programming language, or node.js which is an event-driven server-side JavaScript environment. In the present case, the code is specialized to execute functions described herein which enable a smoother and more efficient technological process.

Computing devices e.g. terminals or readers that enable a user to engage with the invention in general may include a memory for storing a control program and data, and a processor (CPU) for executing the control program and for managing the data, which includes user data resident in the memory and includes buffered content. The computing device may be coupled to a video display such as a television, monitor, or other type of visual display while other devices may have it incorporated in them (iPad, iPhone etc.). An application or an app or other simulation may be stored on a storage media such as a USB memory key, flash memory, or other type of memory media all collectively referred to as “removable media” in this disclosure. The app may also be downloaded from the internet. The removable media can be inserted to the console of a computing device where it is read. The console can then read program instructions stored on the removable media and present a user interface to the user. The user interface may preferably be a graphical user interface (GUI).

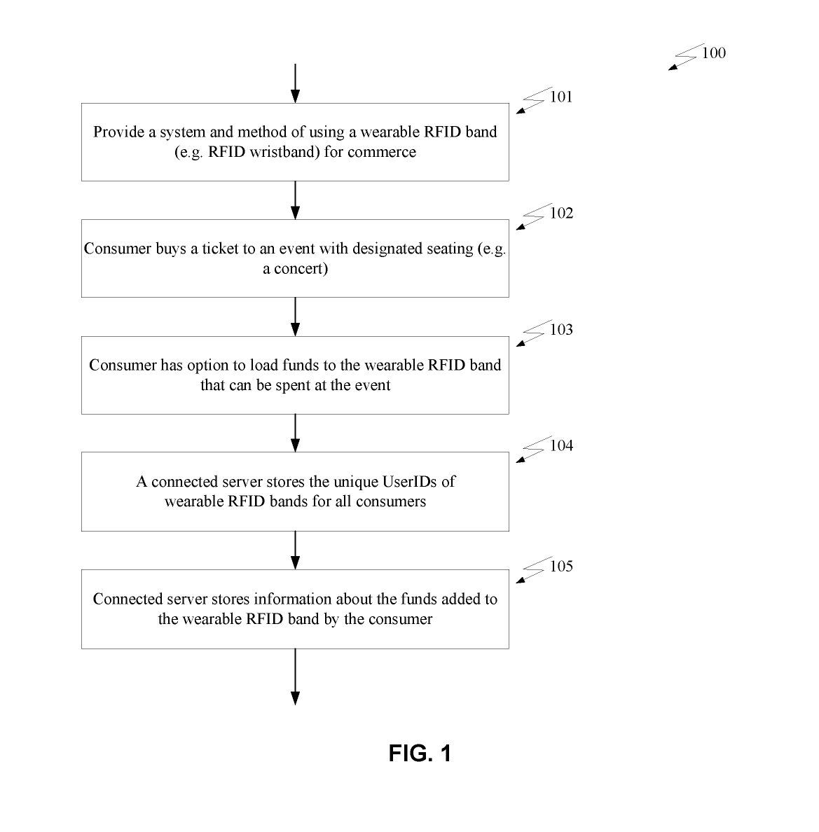

FIG. 1 shows a flow diagram illustrating a basic method for issuance and use of wearable RFID bands for an event, according to the preferred embodiment 100. A system and method of using wearable RFID band (e.g. RFID wristband) for commerce is provided 101. Such a system and method uses electronic touchless, cashless payments through RFID tags embedded in wristbands or similar wearable items. In the preferred embodiment the system and method may be implemented with an RFID tag embedded in a wristband or a similar wearable item which is given to a consumer when visiting (or before attending) a certain event.

In the preferred embodiment, a wearable RFID band is implemented as an RFID wristband that can be worn by a consumer around the wrist. But this could be any format of band that is worn (at least in part) on a part of the user's body. For example, the band element may be a wristband, headband, ankleband, ring, necklace, fob, tag, badge, eyewear, or lanyard. The band should be understood to be any type of band that has an RFID tag embedded in it.

Some embodiments of related systems have described in applicants' copending U.S. patent application Ser. No. 14/717,234 (filed May 20, 2015) and Ser. No. 14/946,287 (filed Nov. 19, 2015), the disclosures of which are incorporated herein by reference.

In such an embodiment the initial state of the terminal is an inactive state. When the consumer taps the RFID tag to the RFID reader, the RFID reader reads the RFID tag which activates the terminal. The terminal is only activated once a valid RFID tag has been tapped at the RFID reader by a consumer. This prevents a sales person (or other third party) from fraudulently adding any items unwanted by the consumer to the order. The system checks the validity of the RFID tag by comparing the UserID of the RFID tag with the UserIDs stored in the database on the server. If the RFID tag is valid, only then is the transaction allowed to proceed (e.g. a sales person can add products to a sales transaction). Once the consumer confirms the transaction with the second tap of the RFID tag to the RFID reader, the system validates the RFID tag a second time by comparing the UserID of the RFID tag captured with the first tap with the UserID of the RFID tag captured with the second tap. Only when the UserIDs of the two RFID tag taps are the same is the transaction completed. In the case of a sales transaction, funds are transferred funds from the RFID tag to the sales merchant. In the case of an admission transaction, the user is allowed through the gate (or to enter a designated zone). With the completion of the transaction the terminal returns to an inactive state.

Before the event begins, the consumer buys a ticket 102, such as a concert being held at a particular date and a particular venue.

In one embodiment the wearable RFID band (e.g. an RFID wristband) is delivered immediately to the consumer upon purchase at a venue box office via a thermal printer or at a point of sale or at the entrance of the event venue where the “document confirming an online purchase” is swapped for a wearable RFID band. A thermal printer may be used for encoding wristbands and tags, passive RFID smart labels and cards. Much like a laser printer uses ink is used to print, the RFID printer uses aluminum (or other metal or conductive) particles to print a circuit on the surface and the information is also encoded in the circuit.

The wearable RFID band may be printed with the information about the user's assigned seating, e.g. the section, row and seat number, allowing the user to benefit from RFID technologies in a reserved seated environment.

The consumer has option to load funds to the wearable RFID band that can be spent at the event 103. For example, at the time of buying tickets the consumer may opt to add $100 that can then be used via the wearable RFID band to sample or purchase different products being showcased at the event. Thus when the consumer arrives at the concert and is given the wearable RFID band that has the designated seating information, it includes a privilege to spend $100 at the different sales booths set up at the venue. The band may also include coupons for certain products.

A connected server stores the unique UserIDs of wearable RFID bands for all consumers 104, e.g. RFID wristbands for consumers, and also stores the designated seating information. The connected server is accessible over a network e.g. a LAN or a WAN or over the internet.

In one embodiment the payment system may be implemented in a closed-loop transaction model. General purpose and limited-purpose payments networks primarily operate under two different business models; open-loop payments networks and closed-loop.

Open-loop payments networks, such as Visa and MasterCard, are multi-party and operate through a system that connects two financial institutions—one that issues the card to the cardholder, known as the issuing financial institution or issuer, and one that has the banking relationship with the merchant, known as the acquiring financial institution or acquirer—and manages information and the flow of value between them.

In closed-loop payments networks, the payment services are provided directly to merchants and cardholders by the owner of the network without involving third-party financial institution intermediaries. Closed-loop payment networks can range in size from networks such as American Express and Discover, which issue cards directly to consumers and serve merchants directly, to an individual merchant that issues limited-purpose private-label credit cards to its customers for use only in that merchant's stores.

In the preferred embodiment the closed-loop payment network may be implemented using Intellitix Virtual Tokens. A Virtual Token is a credit acquired by the consumer via Intellitix cashless application which can thereafter be used to pay for purchases made at the event where the closed loop network is deployed.

The connected server stores information about the funds added to the wearable RFID band by the consumer 105 and available on the wearable RFID band for the consumer to spend at the event. The connected server is accessible over a network e.g. a LAN or a WAN or over the internet.

The venue/event may be set up with one or more terminals (e.g. sales or admission terminals) with RFID readers, one or more RFID top-up terminals with RFID readers and a connected server that stores the UserIDs of the wearable RFID bands, associated seating information, balance of funds available, age information, zone restriction/privileges information, etc., for each user. The server is accessible by the sales terminals and the top-up terminals over a network for example a local area network (LAN).

In one embodiment the system may use standardized RFID tags (ICODE SLI2 15693 on 13.56 MHz (HF)), the most common tag type for inventory tracking, though it may also use other type of RFID tags.

RFID tags contain at least two parts: an integrated circuit for storing and processing information, modulating and demodulating a radio-frequency (RF) signal, collecting DC power from the incident reader signal, and other specialized functions; and an antenna for receiving and transmitting the signal. The tag information is stored in a non-volatile memory. The RFID tag includes either a chip-wired logic or a programmed or programmable data processor for processing the transmission and sensor data, respectively.

Such RFID tags have a memory which has two sectors: the ROM (read only memory) and the R/W (read/write) memory. The ROM is to store the UserID (also known as UID) of the RFID tag, this information is burnt to the ROM at the time of manufacturing and cannot be changed later. The second sector of the memory is a R/W memory, here transactional information is stored e.g. information such as balance, one or more previous transactions, zone restrictions, age limit, etc. Such information may be preferably stored in an encrypted format. The preceding list of items stored on the RFID tag is exemplary and the invention is not limited to these examples.

An RFID reader transmits an encoded radio signal to interrogate the RFID tag. The RFID tag receives the message and then responds with its identification and other information. This may be only a unique tag serial number, or may be product-related information such as a stock number, lot or batch number, production date, or other specific information. In case of the double tap payment method, the balance is written to the RFID tag in addition to some other information such as balance, age limit and zone restrictions etc.

Signaling between the reader and the RFID tag may be done in several different ways, depending on the frequency band used by the RFID tag. RFID tags operating on LF (Low Frequency) and HF (High Frequency) bands are, in terms of radio wavelength, very close to the reader antenna because they are only a small percentage of a wavelength away. An RFID tag is electrically coupled with the transmitter in the reader. The RFID tag can modulate the field produced by the reader by changing the electrical loading the tag represents. By switching between lower and higher relative loads, the RFID tag produces a change that the RFID reader can detect. At UHF (Ultra High Frequency) and higher frequencies, the RFID tag is more than one radio wavelength away from the reader, requiring a different approach.

When written into the RFID tag by an RFID printer, the tag contains a 96-bit string of data. The first eight bits are a header which identifies the version of the protocol. The next 28 bits identify the organization that manages the data for this tag; the organization number is assigned by the EPCGlobal consortium. The next 24 bits are an object class, identifying the kind of product; the last 36 bits are a unique serial number for a particular tag. These last two fields are set by the organization that issued the RFID tag. Similar to a URL, the total electronic product code number can be used as a key into a global database to uniquely identify a particular product.

Generally, the read range of an RFID tag is limited to the distance from the reader over which the tag can draw enough energy from the RFID reader field to power the tag. RFID tags may be read at longer ranges than they are designed for by increasing reader power.

In one embodiment the terminal is only activated once a valid RFID tag has been tapped at the RFID reader by a consumer. This prevents a sales person from fraudulently adding any items unwanted by the consumer to the order.

In one embodiment, the sales terminal may also be activated when a non-valid tag is tapped, and it may display a message “invalid tag”.

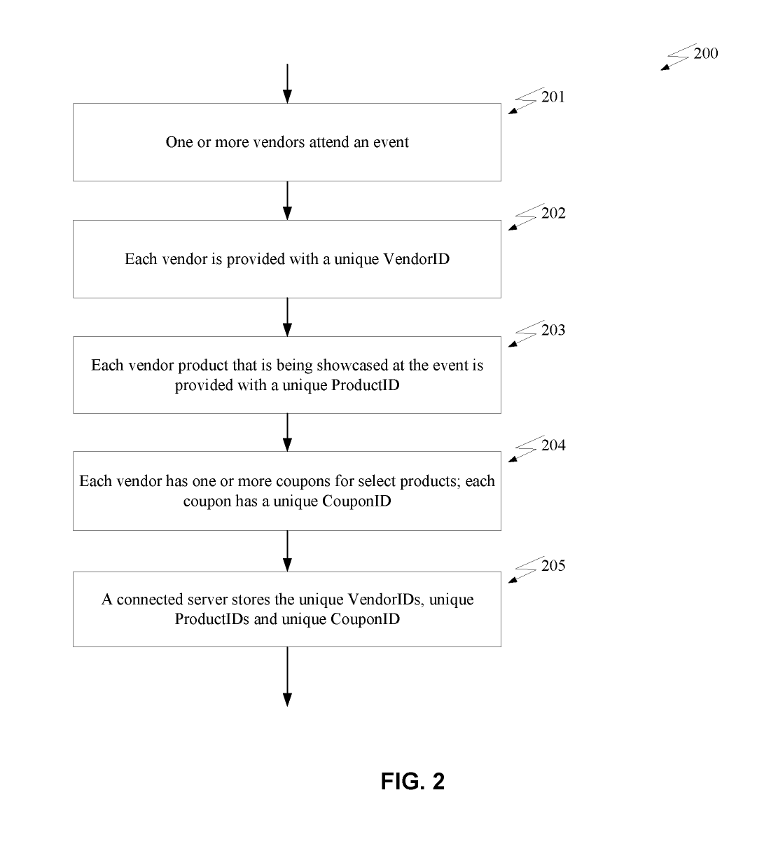

FIG. 2 shows a flow diagram illustrating the use of VendorID, ProductID and CouponID codes according to one embodiment 200. One or more vendors attend an event 201. For example, at a concert, vendors may include food and beverage vendors, and vendors of artist related merchandise such as T-shirts, posters, CDs, and DVDs.

Each vendor is provided with a unique VendorID 202.

Each vendor product that is being showcased/sold at the event is provided with a unique ProductID 203. Since each vendor may have multiple products that they are vending to the consumers attending the concert; each VendorID may be associated with multiple ProductIDs.

Each vendor may have one or more coupons for select products; and each coupon has a unique CouponID 204. For example, a vendor may have one or more coupons for select products that are discounted for specific customers. Each coupon has a unique CouponID, therefore one VendorID may be associated with one or more CouponIDs.

A connected server stores the unique VendorIDs, unique ProductIDs and unique CouponIDs 205. The connected server is accessible over a network e.g. a Local Area network (LAN) or a Wide Area Network (WAN) or over the internet. The unique VendorIDs and unique ProductIDs may be stored in a database or a file.

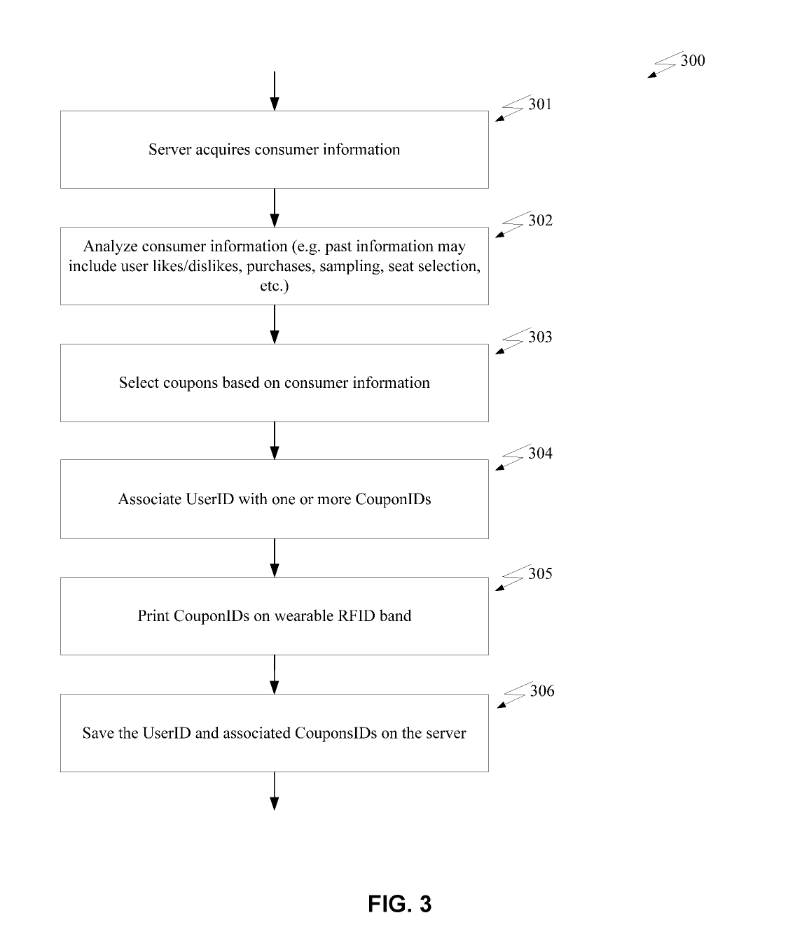

FIG. 3 shows a flow diagram illustrating the selective issuance of coupons according to one embodiment 300. The server acquires consumer information 301. This information may be acquired from a local source such as a database where consumer information has been accumulated and saved over a period of time.

Consumer information may be analyzed (e.g. past information may include user likes/dislikes, purchases, sampling, seat selection, etc.) 302, e.g. from one or more events where the consumer may have purchased or sampled different products. Such information may include but is not limited to user likes/dislikes on different social media networks e.g. Facebook, past purchases, sampling at different events, previous seat selection, dollar amounts spent, coupons used etc.

In an alternate embodiment some or all of the consumer information may be acquired from one or more third parties that may have collected data regarding the consumer.

Coupons may be selected based on consumer information 303 and matched to individual consumers based on consumer information analyzed earlier.

The UserID may be associated with one or more CouponIDs 304 of the selected coupons.

CouponIDs may be printed on wearable RFID band 305 along with the UserID. The UserID and associated CouponsIDs may be saved on the server 306.

In one embodiment the UserIDs and the associated CouponIDs are saved to the server and saved to the RFID wristband of the consumer. In an alternate embodiment the UserIDs and the associated CouponIDs are only saved to the server and are retrieved when a consumer taps the RFID wristband at a sales terminal using UserID to query the server to see which coupons are associated with the said UserID.

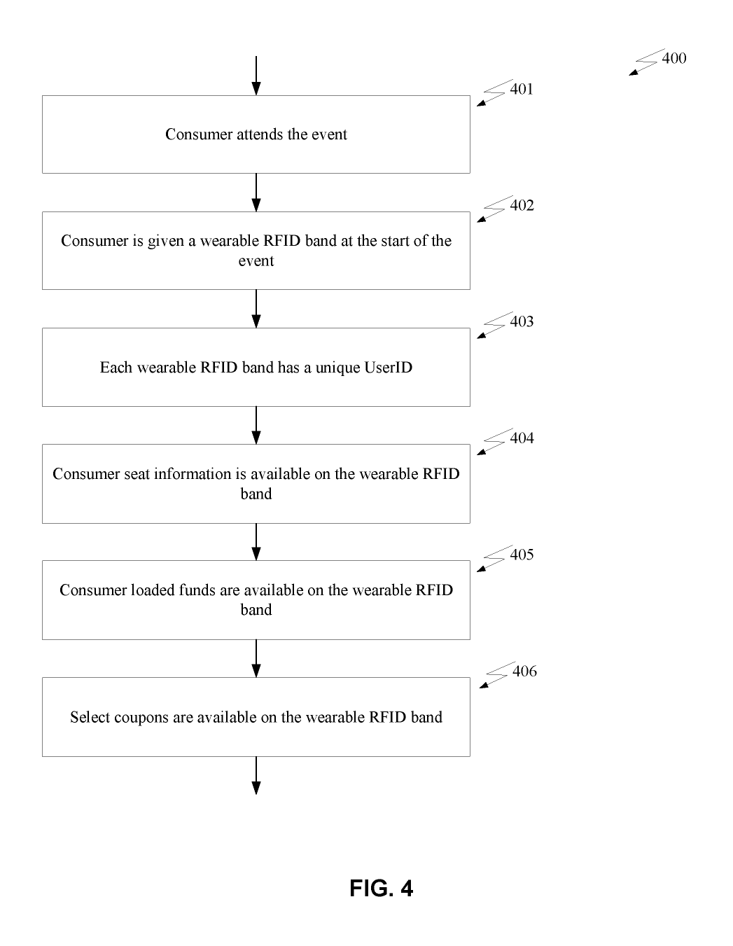

FIG. 4 shows a flow diagram illustrating the issuance of RFID wristbands at an event according to one embodiment 400. A consumer attends the event 401, for example a concert or a sporting event.

The consumer is given a wearable RFID band e.g. a RFID wristband at the start of the event 402. In one embodiment each consumer is given an RFID wristband at the start of the event. In alternate embodiments when a consumer is purchasing the tickets or paying for the admission to the event online in advance, the RFID tag may be mailed (or otherwise distributed) to them prior to the start of the event.

In the preferred embodiment the wearable RFID band (RFID tag) may be printed at the time when the consumer arrives at the event. In one embodiment the wearable RFID band is delivered immediately to the consumer upon purchase at a venue box office via a thermal printer or at a point of sale or at the entrance of the event venue where the “document confirming an online purchase” is swapped for a wearable RFID band.

In one embodiment the wearable RFID band (RFID wristband) may be printed with the information about the assigned seating e.g. the section, row and seat number allowing the consumer to benefit from RFID technologies in a reserved seated environment.

In one embodiment the wearable RFID band may be generated by a thermal printer. A thermal printer may be used for encoding wristbands and tags, passive RFID smart labels and cards.

Each wearable RFID band has a unique UserID 403. In one embodiment each wearable RFID band has a unique UserID. This UserID may be printed to the generic RFID band using the RFID printing method described above.

Consumer seat information is available on the wearable RFID band 404. In one embodiment the seat information of each consumer and the associated UserIDs are stored on the server and the information read from the RFID tap is validated against the information stored in the server.

The wearable RFID band may preferably contain the age or date of birth information about the consumer. Alternatively the server may also store this information so that when a wearable RFID band is read by the RFID reader at the sales terminal the age is verified before allowing a sales person to add any products to the sales transaction (e.g. alcoholic beverages or other age-restricted goods or services). The age verification may be done by using the UserID of the wearable RFID band, connecting to the server and querying the server for the age information before allowing a sales person to add any age restricted products to the sales transaction.

In one embodiment the server may preferably store the age or date of birth information about the consumer, so that when an wearable RFID band is read by the RFID reader at the sales terminal the age can be verified before allowing a sales person to add any age restricted products to the sales transaction. Alternatively the wearable RFID band and the server both may store the age and date of birth information about the consumer.

Thus if the bearer of the wearable RFID band is not over the age limit optionally display a notification and disallow a sales person to vend age restricted products to that consumer. While if the bearer of the wearable RFID band is over the age limit allow the sales person to add age restricted products being vended to the sales transaction.

Consumer loaded funds are preferably available on the wearable RFID band (e.g. an RFID wristband) 405.

Select coupons may also be available on the wearable RFID band 406. One or more coupons may be associated with the UserID of the wearable RFID band and available to the consumer for purchasing and/or sampling different products and services at the event.

Each consumer may have a different set of coupons available to them based on his/her profile which may include age, sex, area of residence, income, previous purchasing and sampling at different events, likes, dislikes etc.

In the preferred embodiment only CouponIDs are written to the wearable RFID band. The actual details of the coupon discount (and associated conditions if any e.g. expiry date, limit on quantity etc.) may be stored on the connected server.

In an alternate embodiment the CouponIDs and details may be written to the wearable RFID band and the server.

The preferred embodiment may advantageously use the double tap RFID transaction method where a first tap of the RFID tag (wearable RFID band) activates the sales terminal and allows the sales person to add the vended products to the sales transaction and a second tap of the RFID tag (wearable RFID band) completes the sales transaction. For the sake of brevity, these steps are omitted from the detailed description that follows.

In one embodiment when the consumer taps wearable RFID band to a RFID sales terminal before trying a first beverage (e.g. wine) other checks and verifications may also be performed in the background. In one embodiment the system of invention checks the age of the consumer before allowing the sale of an age restricted product to go through. Other checks may include zone or other privileges (e.g. press access, or backstage access).

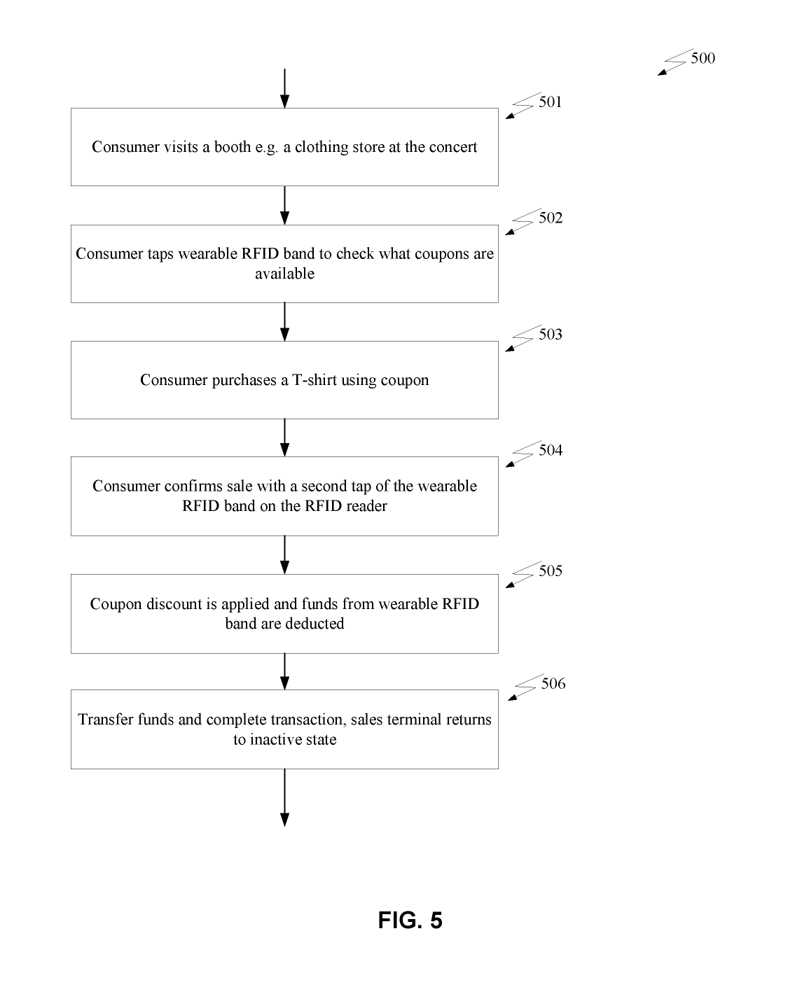

FIG. 5 shows a flow diagram illustrating the use of RFID wristbands for purchase transactions with coupons at an event according to one embodiment 500. A consumer visits a vendor booth, e.g. a clothing store, at the event 501.

The consumer taps the wearable RFID band to check what coupons are available 502. The CouponIDs associated with the UserID of the wearable RFID band may be printed and stored on the wearable RFID band. In an alternate embodiment the UserID acquired from the reading of the wearable RFID band when a user taps the wearable RFID band, is used to query the server to acquire the associated coupons or CouponIDs.

The consumer purchases a T-shirt using coupon 503.

The consumer confirms the sale with a second tap of the wearable RFID band on the RFID reader 504.

At this point, the coupon discount is applied and funds from wearable RFID band are deducted 505.

Funds are transferred and the transaction is completed. The sales terminal returns to inactive state 506.

In one embodiment when a consumer avails himself of a coupon or samples or purchases a product one or all of the CouponID, ProductID and VendorID are saved to the server and saved to the wearable RFID band of the consumer. In an alternate embodiment the CouponID, ProductID and VendorID are saved to both the server and the wearable RFID band of the consumer.

In one embodiment when the consumer enters and leaves the clothing store, wearable RFID band UserID and VendorID is captured and saved to the server. Some or all information may also be saved to the wearable RFID band.

In one embodiment consumer wearable RFID band UserID and timestamp are captured at entry and departure from all vendor stores. The captured UserID and timestamp are saved to the server or the wearable RFID band or both.

In one embodiment this information may be first saved to the wearable RFID band in real time, but may be uploaded to the server asynchronously. In an alternate embodiment this information is saved to both the wearable RFID band and the server in real time.

In another embodiment both the VendorID and the UserID may be captured and stored on the wearable RFID band and the server at the time of entry and at the time of departure. In other alternate embodiments other combinations of VendorIDs and UserIDs may be captured and stored on the wearable RFID band, the connected server, the sales terminal, the top-up terminal or other such storage device or mechanism.

Thus by tracking the wearable RFID band UserID of a particular consumer over a period of time when attending an event, along with the VendorIDs of the stores visited and the CouponIDs of the coupons used and the ProductIDs of products purchased or sampled, a complete consumer profile can be assembled that reflects the consumer's purchasing and sampling preferences during that visit. This information can be aggregated or broken down as necessary for analytics (e.g. by event, by vendor, by individual user, by users of a certain profile or demographic, by users in a particular section, etc.).

In one embodiment the event may be divided into one or more zones. The different zones in a concert may be required in order to segregate the consumers based on their age or their seating arrangement or their payment levels. For example an event may have a designated area where alcoholic beverage can be sampled or purchased, that is only accessible to persons aged 19 or over and any products/services being vended in this zone may only be sampled/purchased by these people. The wearable RFID band may preferably contain this information that defines the zone(s) where the wearable RFID band is valid. Alternatively the server may also store this information so that when an wearable RFID band is read by an RFID reader at a sales terminal it can verify the zone restrictions/privileges by connecting to the server and querying UserID of the wearable RFID band and checking it's restrictions/privileges before allowing a sales person to add any products to the sales transaction.

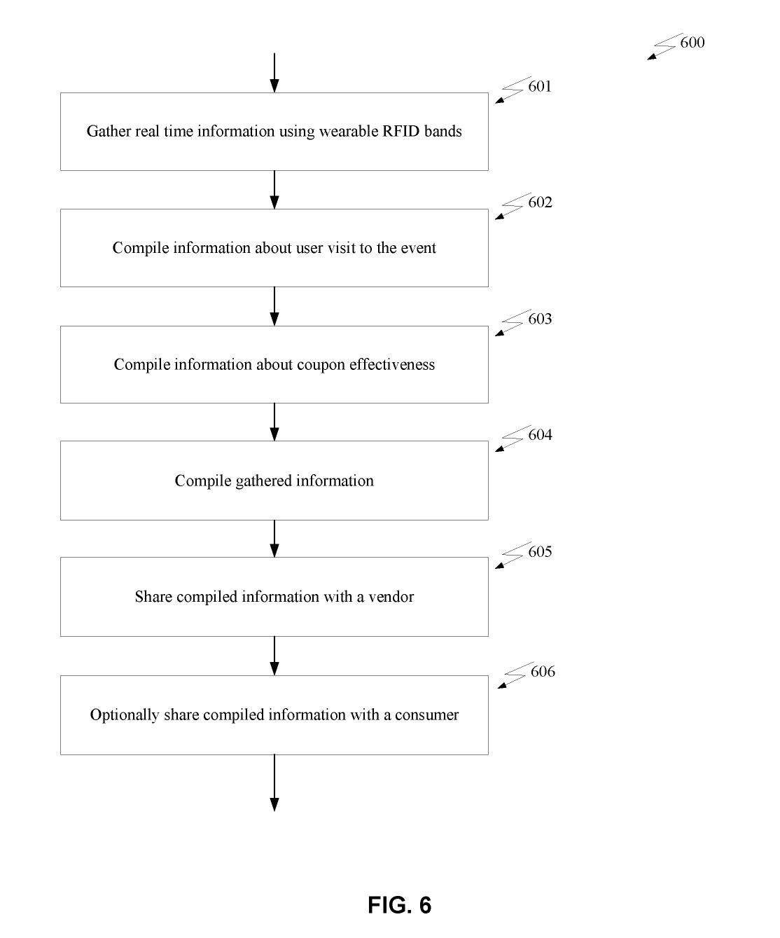

FIG. 6 shows a flow diagram of compilation of information from RFID wristband use at an event according to one embodiment 600. Real time information is gathered using wearable RFID bands 601, e.g. when consumer entered a store, what products were sampled or purchased in what order they were sampled or purchased, and when did the consumer leave the store.

Information is compiled about the consumer visit to the event 602, such as information about the consumer's visit to the different zones or stores during the event. For example, the compiled information may track that a consumer visited a food/beverage store before the start of the event and purchased beer and/or wine, and visited the music store at intermission and purchased a CD, then visited a clothing store and purchased a T-shirt showing the performer or sporting team playing at the venue.

Information is compiled about coupon effectiveness 603. The coupon effectiveness may be determined based on how many coupons were given to the consumer at the start of the event, what coupons did the consumer use, what coupons encouraged the consumer to purchase items other than the ones being offered at a discount, did the coupons encourage a consumer to purchase more than another consumer who was perhaps not provided any coupons etc.

The gathered information is compiled 604. In one embodiment information is compiled about consumer purchasing/sampling of products. Thus for the example above the consumer when visiting the food and beverage store at the start of the concert and during intermission goes to a clothing store and purchases a T-shirt, then visits the music store and samples music from various CDs. Thus which T-shirt was purchased; which music CDs and which specific tracks were sampled may be gathered using the wearable RFID band.

The compiled information may be shared with a vendor 605, e.g. how many consumers visited the vendor's store. In one embodiment the information about all consumers who visited the store of a particular vendor may include but is not limited to the following:
Coupon effectiveness i.e. did the consumer avail the discount offers in coupons
How many coupons were issued and how many were availed
Which coupons were most used
What was the peak time at the booth in terms of traffic
What was the slow time at the booth in terms of traffic
When most sales were conducted
When least sales were conducted
Average time consumers spent in the booth (by capturing entry time and departure time)
Average consumer spending at the vendor
In what sequence consumers visited (which booth was visited first, which booth was visited last etc.)
Which products were sampled most
Which products were purchased most
Which products were sampled least
Which products were purchased least

In one embodiment the information about a particular consumer who visited the store of a particular vendor may include but is not limited to the following:
Coupon effectiveness i.e. did the consumer avail the discount offers in coupons
How many coupons were issued and how many were availed by said consumer
Which coupons were most used
When did the consumer visit the booth
Was consumer visit during peak time or during slow time
How much time did this consumer spend and how it compares to the average time for all consumers who visited this booth
How much did this consumer spend and how it compares with the average consumer spending at this vendor
In what sequence did this consumer visit the vendor booth
Which products were sampled
Which products were purchased
Ratio of sampled products to purchased products

Compiled information may be sent to the vendor via an attached file in an e-mail, mailing printed results, a link to the compiled information that is accessible over the internet, and other electronic methods conducive to sharing and sending information over the internet.

Optionally, the compiled information may be shared with a consumer 606, e.g. about the consumer's visits to different stores and the products purchased or sampled at each of the stores visited.

This information may be shared with a consumer via an attached file in an e-mail, mailing printed results, a link to the compiled information that is accessible over the internet, and other electronic methods conducive to sharing and sending information over the internet.

In one embodiment the information about a particular consumer who visited the event may include but is not limited to the following:
How many stores did the consumer visit
Coupon effectiveness i.e. did the consumer avail any of the discount offers in coupons
How many coupons were issued and how many were availed by said consumer
Which coupons were most used by said consumer
In what order did the consumer visit these stores
Time spent at each of the stores
Which products were sampled and or purchased at each store visited
How much did the consumer spend in total at the event
How much did the consumer spend at each store
What products were purchased/sampled by the consumer
What products were most popular at the event
In what sequence products were sampled at a given store
Comparison of consumer time spent at the store with the average time of all consumers at the same store
Comparison of consumer spending at the store with the average spending of all consumers at the same store

The above are exemplary and not limiting, and the intent is to cover all such information that may be relevant and gathered at an event and shared with the vendors or consumers attending the event.

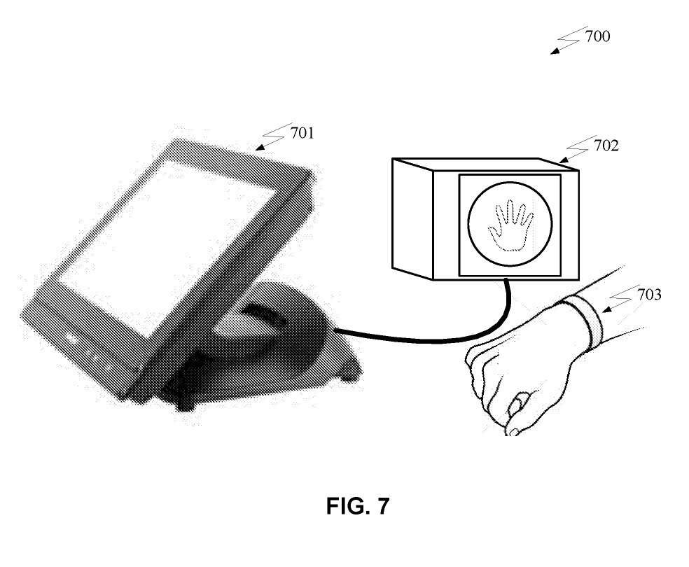

FIG. 7 shows one embodiment of the wearable RFID device in the context of a transaction within an interrogation zone 700. As shown, in this case, the wearable element is a wristband 703, and the RFID tag is embedded in the wristband. The tag is interrogated by an RFID reader 702 of a terminal 701 (such as a sales, admission or top-up terminal). The tag may be readable (through double-tap transactions as provided herein) at any one of multiple terminals in the event space (interrogation zone) (one such terminal shown). A server may be provided (either on- or off-site) to manage, for example, valid UserIDs and store transaction data and funds balances of the tags (may be updated at the time of each transaction or at periodic or batch-wise intervals).

In one embodiment the event may have several terminals setup e.g. admissions terminals at gate and/or zone entrances, one or more sales terminals at each of the participating vendors' stores. The event may also have one or more RFID tag top-up terminals set up at different locations at the venue so that a consumer may opt to add more balance to the wearable RFID band if the balance runs low as a consequence of having sampled or purchased several products/services.

Some embodiments of related systems have described in applicants' copending U.S. patent application Ser. No. 14/717,234 (filed May 20, 2015) and Ser. No. 14/946,287 (filed Nov. 19, 2015), the disclosures of which are incorporated herein by reference.

The double-tap system eliminates the accidental RFID scan loophole that may be used by a consumer later to claim a chargeback.

In one embodiment the validity of the wearable RFID band (RFID tag) is checked by reading its UserID and passing this UserID to the server for validation. The server may have a database or a list of all valid UserIDs for the wearable RFID bands (e.g. all RFID wristbands) that are related to an event e.g. a wine and cheese festival. If the wearable RFID band is valid, allow the sales person to vend product(s). Whereas if the wearable RFID band is not valid, then optionally display a notification and disallow sales person to vend products and return sales terminal to an inactive state.

In one embodiment the sales terminal may only be activated for a sales transaction once a valid and non-zero balance wearable RFID band has been tapped. Thus if the UserID of the wearable RFID band does not match with any of the UserIDs in the list/database on the server then it is considered that the wearable RFID band is not valid. Similarly, if the balance associated with the wearable RFID band is zero or less than the price of the products being sampled or purchased, the sales terminal returns to an inactive state with the RFID reader waiting for the next wearable RFID band to be read. This prevents a sales person to vend any products to a consumer bearing an invalid and zero balance (or low balance) wearable RFID band. Preferably there may be a notification that is displayed on the sales terminal notifying the bearer of the wearable RFID band about the validity and the low balance associated with the wearable RFID band.

In one embodiment in order to complete the sales transaction the funds are transferred from the consumer's account (balance on the wearable RFID band) to the vendor's account. The sales terminal returns to an inactive state with the RFID reader waiting for the next scan of a wearable RFID band to start a new transaction.

The total amount of the sale may be displayed. Consumer confirms the sale with a second tap of the wearable RFID band to the RFID reader. In one embodiment, the second tap of the wearable RFID band to the RFID reader associated with the sales terminal confirms the consumer's intent and willingness to purchase the products/services being vended.

The system checks whether it is the same wearable RFID band as the first tap. When the consumer taps the wearable RFID band a second time, the RFID tag is read to get the UserID of the RFID tag. The UserID read from the first tap of the RFID tag is compared with the UserID read with the second tap of the RFID tag. If the comparison shows that the UserID read from the first tap of the wearable RFID band is equal to/same as the UserID read with the second tap then it is confirmed that it is the same consumer who initiated the sales transaction.

If No, the wearable RFID band of the second tap is different from the wearable RFID band of the first tap, then a notification may be displayed and the sales person is disallowed to vend the product. If the comparison shows that the UserID read from the first tap of the wearable RFID band is not equal to/or is different from the UserID read with the second tap then it is concluded that a different consumer is trying to finalize the sales transaction. Thus in one embodiment, the sales transaction is disallowed if the UserID from the first wearable RFID band does not match the UserID of the second wearable RFID band.

If Yes, the wearable RFID band of the second tap is the same as the wearable RFID band of the first tap, then the sales transaction is allowed to proceed. In one embodiment in order to complete the sales transaction the funds are transferred from the consumer's account (balance on the wearable RFID band) to the vendor's account.

A new balance is written to the wearable RFID band. If there is any balance left from this instant transaction the balance is written to the wearable RFID band and the server. If the balance is zero, then the system writes a 0.00 balance to the wearable RFID band and the server. With the completion of a sales transaction the sales terminal returns to an inactive state with the RFID reader waiting for the next scan of an wearable RFID band to start a new sales transaction.

In one embodiment there may be one or more terminals dedicated for wearable RFID band top-up. The consumer may preferably first be able to check the balance on their wearable RFID band by tapping the wearable RFID band at the RFID reader associated with the top-up terminal. Preferably the consumer may add more balance to the wearable RFID band via the top-up terminal for later use.

The preferred embodiment may provide a graphical user interface utilizing which a consumer may top up the balance on the wearable RFID band. Preferably there may be a drop down menu or a list with selection radio buttons or any other user friendly method using which a consumer may choose the amount and the payment method for the wearable RFID band top-up e.g. credit card, bank account etc.

In one embodiment the validity of the wearable RFID band is checked with the server. If the wearable RFID band is not valid, then a notification is displayed and an operator is disallowed to top-up the wearable RFID band and the sales terminal is returned to an inactive state.

In one embodiment there may be a person e.g. an operator who assists a consumer with the wearable RFID band top-up process. In another embodiment the wearable RFID band top-up terminal may be self-serve where the consumers follow instructions to top-up the wearable RFID bands themselves.

In one embodiment, the second tap of the wearable RFID band to the RFID reader associated with the top-up terminal confirms the consumer's intent and willingness to top-up the wearable RFID band with the amount and type chosen earlier.

The system checks whether the wearable RFID band of the first tap is the same as the wearable RFID band of the second tap. If the comparison shows that the UserID read from the first tap of the wearable RFID band is equal to/same as the UserID read with the second tap then complete the top-up transaction. In one embodiment in order to complete the top-up transaction the funds are transferred from the consumer's account e.g. a credit card to the wearable RFID band.

The new balance is displayed and written to the wearable RFID band.

In one embodiment the last transaction details and the balance are written to the wearable RFID band. In one embodiment the wearable RFID band may store the last five transactions, and the balance.

The wearable RFID band top-up transaction is completed and the wearable RFID band top-up terminal is returned to an inactive state with the RFID reader waiting for the next scan of an wearable RFID band to start a new top-up transaction.

In one embodiment the sales terminal may be a self-serve terminal where the consumer may purchase items directly and add items to a sales transaction. In one embodiment the consumer starts the sales transaction by first tapping the wearable RFID band to the RFID reader, adding products to the sales transaction and then finalizing the sale with the second tap of the wearable RFID band to the RFID reader.

In one embodiment even if no products were sampled or purchased by a consumer at the event using the wearable RFID band, the consumer has the opportunity to express their intent to purchase or learn more about vendor showcased products by using a LiveClick Station. A LiveClick Station may be an RFID equipped terminal with a graphical user interface e.g. a touchscreen, using which a consumer may choose one or more vendor showcased products and tap their wearable RFID band to identify themselves. This establishes a relationship between the consumer and the vendor as a consumer expresses their intent by selecting options like “I am interested in this product” or “I am interested in this product and would like more information about it” etc.

In one embodiment the LiveClick Station may be used during the event or after the event is over. In another embodiment the LiveClick Station product selection information may be used in addition to the information gathered via the sampling and purchasing of different products at various booths during the event.

In one embodiment the details of some or all transactions may be stored on the wearable RFID band.

In one embodiment the wearable RFID bands are customized before usage. In an alternate embodiment the system and method may use generic RFID tag for example RFID tags having an ICODE SLI2 15693.

One embodiment may use Active Reader Passive Tag (ARPT) system that has an active reader, which transmits interrogator signals and also receives authentication replies from passive RFID tags.

In one embodiment the RFID tags may be embedded in any kind of item whether it is wearable e.g. a wristband, an ankle-band, a pair of sunglasses, or it can be a badge etc.

In one embodiment the unique UserIDs of the wearable RFID band to be used at an event are stored on a server that is accessible over the network. In the preferred embodiment the list of unique UserIDs of wearable RFID band may be available in a CSV (Comma Separated Values) format from the supplier. This CSV file is then uploaded to the server. The system then automatically initializes the wearable RFID band by creating a unique encryption method for that specific tag and writes the offline information to the memory of the RFID tag when the RFID tag first read by an RFID reader in the system.

These descriptions exemplify only some of the several possible embodiments and are not meant to be exhaustive. The intent is to cover all practical possibilities and combinations.

It should be understood that although the term application has been used as an example in this disclosure but in essence the term may also imply to any other piece of software code where the embodiments are incorporated. The software application can be implemented in a standalone configuration or in combination with other software programs and is not limited to any particular operating system or programming paradigm described here.

The computer program comprises: a computer usable medium having computer usable program code, the computer usable program code comprises: computer usable program code for presenting graphically to the users options for scrolling via the touch-screen interface.

The examples noted here are only for illustrative purposes and there may be further implementation embodiments possible with a different set of components. While several embodiments are described, there is no intent to limit the disclosure to the embodiment or embodiments disclosed herein. On the contrary, the intent is to cover all practical alternatives, modifications, and equivalents.

All aspects are illustrative and not restrictive and may be embodied in other forms without departing from their spirit and essential characteristics.

Several exemplary embodiments/implementations have been included in this disclosure. There may be other methods obvious to the ones skilled in the art, and the intent is to cover all such scenarios. The application is not limited to the cited examples, but the intent is to cover all such areas that may benefit from this invention. The examples noted here are for illustrative purposes only and may be extended to other implementation embodiments.

What is claimed is:

1. A wearable RFID band for use at an event in a reserved seating interrogation zone, the zone containing terminals with RFID readers, the band comprising:
a band element worn by a user; and
an RFID tag printed on the band element having stored data representing a UserID of the tag, seat information of the associated user, and a stored funds balance preloaded by the user to an associated account;
the tag being programmed for activating an otherwise inactive one of said terminals upon presentation of the tag to the RFID reader of said terminal in a first tap, and communicating the UserID to the terminal for a first validation against valid UserIDs and associated user data stored on a server;
the tag being further programmed, following a transaction request and a second tap of the tag at the RFID reader, for triggering a second validation that the UserID at the second tap matches the UserID of the first tap;
wherein the transaction request is granted only if both of the validations are positive.

2. The wearable RFID band of claim 1, wherein the transaction request is a gate admission.

3. The wearable RFID band of claim 1, wherein the transaction request is a zone admission.

4. The wearable RFID band of claim 1, wherein the transaction request is a purchase of a good or service for a transaction amount wherein grant of the request entails a decrease of the stored funds balance by the transaction amount.

5. The wearable RFID band of claim 1, wherein the transaction request is a top-up transaction by a transaction amount wherein grant of the request entails an increase of the stored funds balance by the transaction amount.

6. The wearable RFID band of claim 1, wherein the transaction request is a refund transaction by a transaction amount wherein grant of the request entails an increase of the stored funds balance by the transaction amount.

7. The wearable RFID band of claim 1, wherein the band element is configured to be worn around a body part of the user.

8. The wearable RFID band of claim 1, wherein the band element is a wristband, headband, ankleband, ring, necklace, fob, tag, badge, eyewear, or lanyard.

9. The wearable RFID band of claim 1, wherein the band element is a disposable element.

10. The wearable RFID band of claim 1, wherein the RFID tag is printable on the band element at the event.

11. The wearable RFID band of claim 1, wherein the RFID tag is an ICODE SLI2 15693 tag.

12. The wearable RFID band of claim 1, wherein the RFID tag communicates with the readers using an Active Reader Passive Tag (ARPT) system.

13. The wearable RFID band of claim 1, wherein the tag is further programmed to deactivate or hibernate after a predetermined time, or following the event.

14. The wearable RFID band of claim 1, wherein the stored data further comprises at least one credential.

15. The wearable RFID band of claim 14, wherein the credential is an age or date of birth credential.

16. The wearable RFID band of claim 1, wherein the interrogation zone is in a stadium, arena, concert hall, theatre, or auditorium.

17. The wearable RFID band of claim 1, wherein the tag is further programmed to cause the reader to communicate a timestamp associated with the transaction request when granted.

18. The wearable RFID band of claim 17, wherein a timestamped record of all transaction requests is stored associated with the user.

19. The wearable RFID band of claim 17, wherein a timestamped record of all transaction requests is stored associated with the event.

20. The wearable RFID band of claim 1, wherein the stored data also includes at least one CouponID associated with a coupon for a good or service having a ProductID, the coupon being retrieved and automatically processed when the user's transaction request for a purchase associated with the ProductID is granted.

21. The wearable RFID band of claim 20, wherein the coupon is selected for the user based on associated user data stored on the server.
